(19) United States
(12) Patent Application Publication
(10) Pub. No.: US 2009/0149070 A1
(43) Pub. Date: Jun. 11, 2009

(54) ALL-IN-ONE CARD CONNECTOR

(75) Inventor: Dong-Chu Feng, Dongguan (CN)

Correspondence Address: PATENTTM.US, P. O. BOX 82788, PORTLAND, OR, 97282-0788, US

(73) Assignee: Comtek Electronics Co., Ltd., Dongguan (CN)

(21) Appl. No.: 12/267,443

(22) Filed: Nov. 7, 2008

(30) Foreign Application Priority Data
Dec. 10, 2007 (CN) 200720312111.1

(51) Int. Cl. H01R 24/00

(52) U.S. Cl. 439/630

(57) ABSTRACT

An all-in-one card connector has a insulating case, a first base, a second base, a single card terminal assembly and multiple modular card terminal assemblies. The single card terminal assembly is formed on the first base and is inserted into one end of the insulating case. The modular card terminal assemblies are formed on the second base and are inserted into the other end of the insulating case. After inserting, the bases are cut from the single and modular card terminal assemblies. Because multiple modular card terminal assemblies are all formed on the second base, the material for the base is saved to reduce the cost and the mounting process is also simplified.

### BACKGROUND OF THE INVENTION

1. Field of the Invention

The present invention relates to a connector, especially to a card connector.

2. Description of the Prior Arts

The conventional all-in-one card connectors are adapted for connecting MS card (Memory Stick card), SD card (Secure Digital memory card), XD card (extreme Digital Card) and the like. The conventional all-in-one card connectors usually have multiple terminal modules to correspond to different cards.

With reference to FIGS. 1A, 1B and 1C, a conventional all-in-one card connector comprises an MS terminal module (1a), a SD connecting terminal module (2a), a SD write-protection terminal (3a), a SD detecting terminal (4a), a XD terminal module (5a) and an insulating case (6a). Each terminal module (1a, 2a, 5a) is independent from each other. The MS terminal module (1a) comprises multiple MS terminals (1a1) and an MS base (1a2). The MS base (1a2) is formed on one ends of the MS terminals (1a1). The SD connecting terminal module (2a) comprises multiple SD connecting terminals (2a1), a first SD base (2a2) and a second SD base (2a3). The bases (2a2, 2a3) are formed respectively one the ends of the SD connecting terminals (2a1). The XD terminal module (5a) comprises multiple XD terminals (5a1) and a XD base (5a2). The XD base (5a2) is formed on one ends of the XD terminals (5a1). However, the bases (1a1, 2a2, 2a3, 5a2) are cut off when the MS terminal module (1a), the SD connecting terminal module (2a) and the XD terminal module (5a) is mounted in the insulating case (6a). The bases (1a1, 2a2, 2a3, 5a2) are not existed in the final product. Therefore, more bases waste more materials.

To overcome the shortcomings, the present invention provides an all-in-one card connector to mitigate or obviate the aforementioned problems.

### SUMMARY OF THE INVENTION

The main objective of the present invention is to provide an all-in-one card connector that reduces the cost. The all-in-one card connector has a insulating case, a first base, a second base, a single card terminal assembly and multiple modular card terminal assemblies. The single card terminal assembly is formed on the first base and is inserted into one end of the insulating case. The modular card terminal assemblies are formed on the second base and are inserted into the other end of the insulating case. After inserting, the bases are cut from the single and modular card terminal assemblies. Because multiple modular card terminal assemblies are all formed on the second base, the material for the base is saved to reduce the cost and the mounting process is also simplified.

Other objectives, advantages and novel features of the invention will become more apparent from the following detailed description when taken in conjunction with the accompanying drawings.

### BRIEF DESCRIPTION OF THE DRAWINGS

FIG. 1A is an exploded perspective view of a conventional all-in-one card connector in accordance with the prior art;

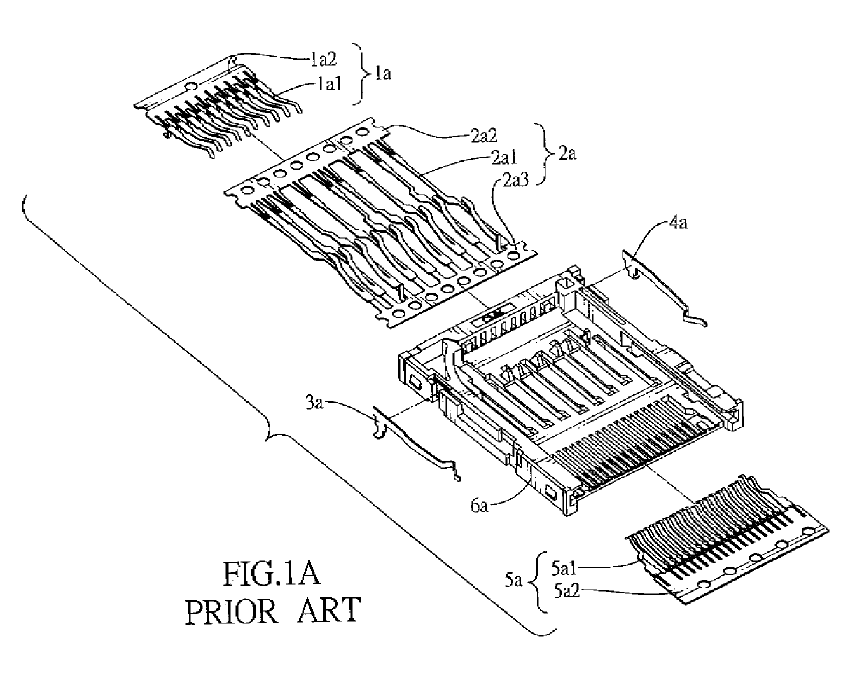

FIG. 1B is a perspective view of the conventional all-in-one card connector in FIG. 1A;

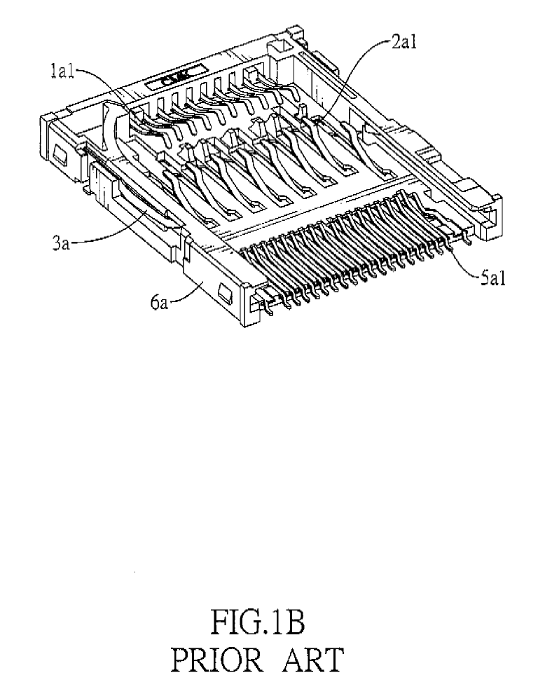

FIG. 1C is another perspective view of the conventional all-in-one card connector in FIG. 1A;

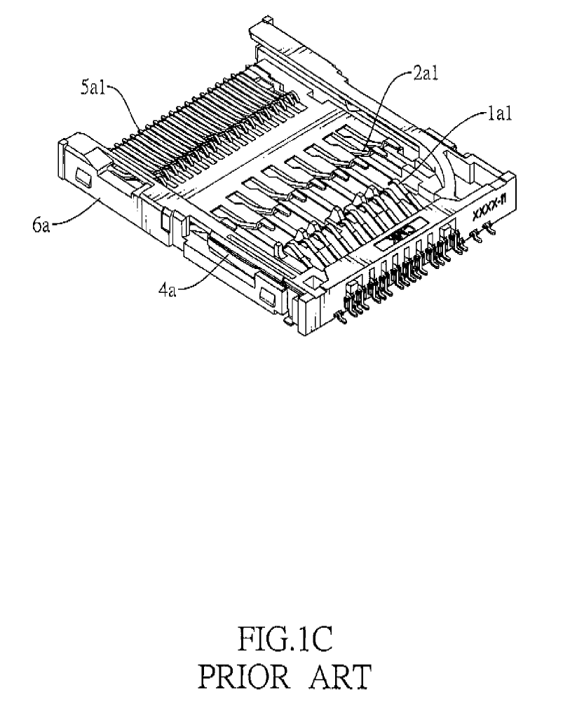

FIG. 2A is an exploded perspective view of an all-in-one card connector in accordance with the present invention; and

FIG. 2B is a perspective view of the all-in-one card connector in FIG. 1.

### DETAILED DESCRIPTION OF THE PREFERRED EMBODIMENTS

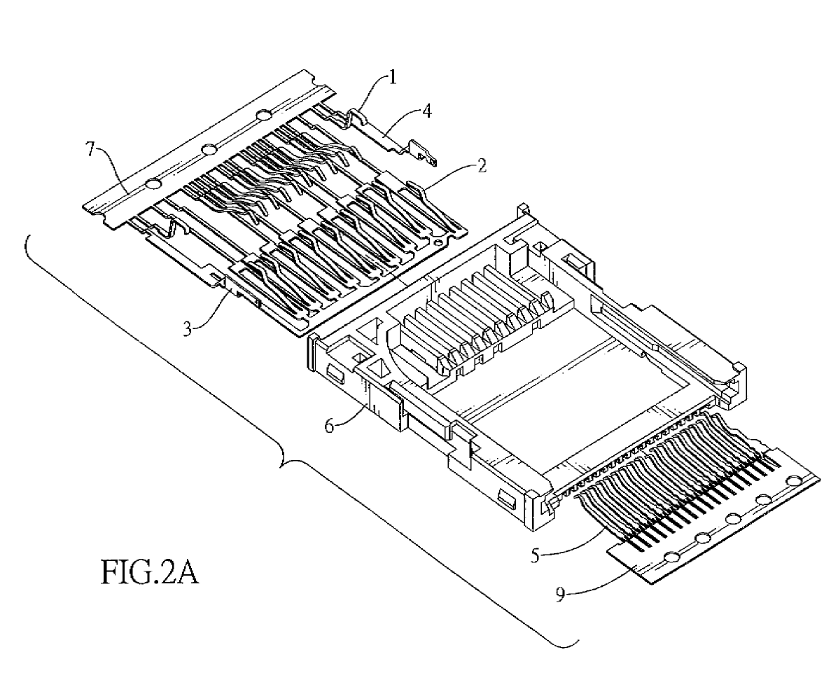

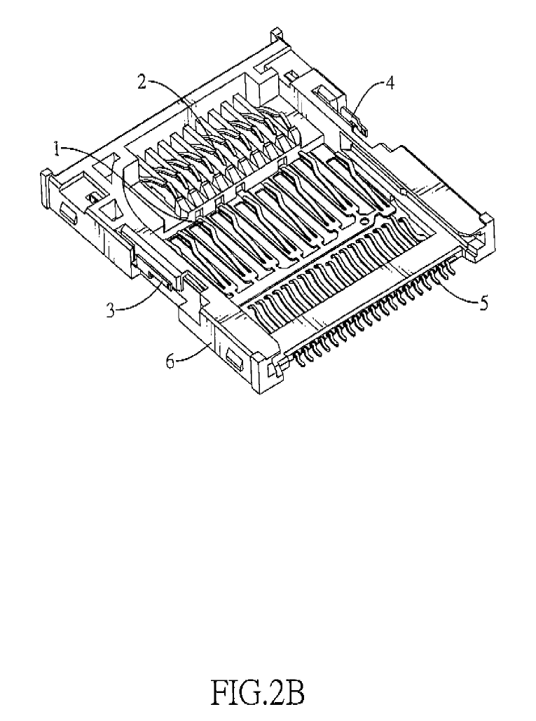

With reference to FIGS. 2A and 2B, an all-in-one card connector in accordance with the present invention comprises an insulating case (6), a first base (9), a second base (7), a single card terminal assembly and multiple modular card terminal assemblies.

The insulating case (6) has a front end opening and a rear end opening.

The first base (9) corresponds to the rear end opening of the insulating case (6).

The second base (7) corresponds to the front end opening of the insulating case (6) and may be a belt.

The single card terminal assembly is formed on the first base (9), is inserted into the rear end opening of the insulating case (6), is a XD terminal assembly (5) and has eighteen terminals.

The modular card terminal assemblies are formed on the second base (7), are inserted into the front opening of the insulating case (6), comprise an MS terminal assembly (1), a SD connecting terminal assembly (2), a SD write-protection terminal assembly (3) and a SD detecting terminal assembly (4). The MS terminal assembly (1) has ten terminals. The SD connecting terminal assembly (2) has nine terminals. The SD write-protection terminal assembly (3) has one terminal. The SD detecting terminal assembly (4) has one terminal.

When the single and modular card terminal assemblies are inserted into the insulating case (6), the bases (7, 9) are cut from the single and modular card terminal assemblies.

The all-in-one card connector in accordance with the present invention has numerous advantages. Because the modular card terminal assemblies are all formed on the second base (7), the cutting and wasting material for the second base (7) is saved to reduce the cost. Furthermore, mounting the multiple modular card terminal assemblies only needs one mounting process. Therefore, the manufacture is simplified, is helpful to enhance the efficiency and the quality

Even though numerous characteristics and advantages of the present invention have been set forth in the foregoing description, together with details of the structure and features of the invention, the disclosure is illustrative only Changes may be made in the details, especially in matters of shape, size, and arrangement of parts within the principles of the invention to the full extent indicated by the broad general meaning of the terms in which the appended claims are expressed.

What is claimed is:

1. An all-in-one card connector comprising:
an insulating case having a front end opening and a rear end opening;
a first base corresponding to the rear end opening of the insulating case;
a second base corresponding to the front end opening of the insulating case;
a single card terminal assembly being formed on the first base and being inserted into the rear end opening; and
multiple modular card terminal assemblies being formed on the second base and being inserted into the front base, wherein when the single and modular card terminal assemblies are inserted into the insulating case, the bases are cut from the single and modular card terminal assemblies.

2. The all-in-one card connector as claimed in claim 1, wherein the second base is a belt.

3. The all-in-one card connector as claimed in claim 2, wherein the modular card terminal assemblies comprise an MS terminal assembly, a SD connecting terminal assembly, a SD write-protection terminal assembly and a SD detecting terminal assembly.

4. The all-in-one card connector as claimed in claim 3, wherein
the MS terminal assembly has ten terminals;
the SD connecting terminal assembly has nine terminals;
the SD write-protection terminal assembly has one terminal; and
the SD detecting terminal assembly has one terminal.

5. The all-in-one card connector as claimed in claim 1, wherein the single card terminal assembly is a XD terminal assembly and has eighteen terminals.

6. The all-in-one card connector as claimed in claim 2, wherein the single card terminal assembly is a XD terminal assembly and has eighteen terminals.

7. The all-in-one card connector as claimed in claim 3, wherein the single card terminal assembly is a XD terminal assembly and has eighteen terminals.

8. The all-in-one card connector as claimed in claim 4, wherein the single card terminal assembly is a XD terminal assembly and has eighteen terminals.
